(19) United States
(12) Patent Application Publication
(10) Pub. No.: US 2008/0120179 A1
(43) Pub. Date: May 22, 2008

(54) Method Of Commerce

(76) Inventors: Leonie Wheeler, Queensland (AU); Matthew Peters, Queensland (AU)

Correspondence Address: Hoffman, Wasson & Gitler, 2461 South Clark Street, Suite 522, Arlington, VA, 22202, US

(21) Appl. No.: 11/579,125

(22) PCT Filed: Apr. 28, 2005
(86) PCT No.: PCT/AU05/00606

§ 371 Date: Jun. 26, 2007

(30) Foreign Application Priority Data
May 7, 2004 (AU) 2004902414
Aug. 10, 2004 (AU) 2004203807

(51) Int. Cl. G06Q 30/00; G07F 7/00; G06F 17/50

(52) U.S. Cl. 705/14

(57) ABSTRACT

A magazine lottery system comprises a unique identification number on each purchased magazine, providing sufficient personal information to identify the purchaser, giving this information to a database, and selecting at least one winner from the database, and optionally televising the winner.

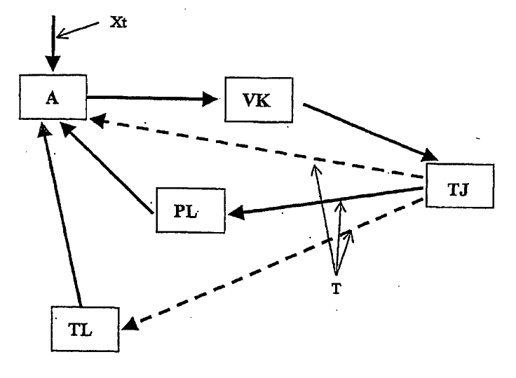

The invention relates to a method for the redemption/transfer of a product, service, payment and/or the like, whereby a customer has received in his/her portable data processing device, such as a mobile phone or the like, equipped with communication links, from a service provider, such as a vendor, a server and/or the like, in the form of a text message an electronic coupon, ticket, betting slip and/or the like, which contains a code or the like for enabling the redemption/transfer of a product, service, payment and/or the like in a controlled fashion.

In electronic commerce, for example, the use of various electronic admission tickets, coupons, betting slips, certificates of purchase, and the like for the redemption of a service or a product can be effected in a variety of ways. For example, it is possible for customers to use customer identifiers to redeem or claim their acquired products or services.

In this case, the customer presents a required customer identifier, such as e.g. his/her customer number, during the course of a purchase transaction, to a service provider to be stored by the same in his/her database along with other information regarding the discussed purchase transaction. When the customer is ready to claim or redeem e.g. a product/service purchased by him/her, he/she will be identified again, after which the service provider transfers or hands over the product/service to the customer on the basis of information present in his/her database.

On the other hand, it is prior known from the publication PCT/FI99/00109 that a customer is given a code during the course of a purchase transaction, which enables him/her to redeem or claim his/her acquisition. Such a code can be implemented in a number of ways: it can be a random number sequence or an alphanumeric code, or it can be for example a digital code secured by encryption. The customer is able to claim his/her acquisition from a service provider by means of said code in such a manner that, if necessary, the service provider checks the code for its authenticity, for example by decrypting the code, as well as checks his/her database to confirm that the code has not been used before, as well as runs the respective necessary checks by means of his/her, system, such that the product/service can be transferred or handed over to the customer. It is also essential about these codes that, as a customer during the course of a redemption process presents a code to a service provider, this enables the service provider to confirm that the customer is entitled to claim this particular service/product.

However, building a system based on the use of codes as described above and intended for the redemption of products/services involves problems regarding both a service provider and a client. First, with regard to a service provider, a system enabling the verification of codes requires that a system be provided at the claiming point, which enables the reading and verification of codes possessed by a customer. For example, if a code giving entitlement to redemption and possessed by a customer is stored in the customer's portable data processing device, the service provider must be able to build a system which enables reading the code present in said data processing device. Therefore, there are various methods in development: in the future, for example, Bluetooth and other systems based on radio signals and intended for short-range communication may provide a solution in terms of building the above type of verification system for codes. On the other hand, some portable data processing devices are even now provided with a capability of infrared communication for verification purposes.

However, designing such systems would require the creation of a universal standard, since for example Bluetooth and other radio-signal based short-range communication systems are only in a developing stage and a long way from general use. At present, there is not even any certainty that those will ever become a standard. On the other hand, infrared communication would be functional in principle even today except that it is impossible for a service provider to take into account all different portable data processing devices available to consumers, in which an infrared system is feasible. In other words, it seems that no such short-range communication standard is being developed, especially between a customer-held portable data processing device, such as a mobile phone, and a verification device held by a service provider, which would enable the verification of codes possessed by a customer in such a manner that a large number of customers could make use of the system at the same time.

From the viewpoint of a service provider, a short-range communication system as described above would also require major investments in systems that would enable the reading and checking of codes, as well as, on the other hand, the presentation of a verification result for making it possible to transfer or hand over a service. For example, the system would require a communication link between each verification or checking device and a database used in the process of creating the codes in order to make verification possible.

A reading and checking system for codes to enable redemption is a factor of major significance also from a client's viewpoint. If a reading/checking system is based, for example, on the application of Bluetooth or infrared communication, the client's data processing device must have a capability of establishing a communication as required by whatever system is in use. A problem here is, however, that portable data processing devices capable of infrared communication, for example, are not in common use, and even those devices, which are provided with infrared communication, function in a variety of ways, and, thus, it is inconvenient for a service provider to account for all various devices capable of infrared communication. On the other hand, even if a given device had a capability of infrared communication, said device would not be necessarily provided, nor can it be retrofitted, with a software for using infrared communication particularly for reading codes.

All in all, the situation at the moment seems to indicate no rapid spreading in the use of code checking systems based on short-range communication, such as Bluetooth or infrared, since those require major initial investments from service providers, as well as system compatible data processing devices for customers.

It is an object of a method according to the present invention to provide a decisive improvement with regard to the above described problems, and hence to raise substantially the present level of prior art. In order to achieve this object, a method of the invention is principally characterized in that, for claiming a product, service, payment, betting prize, discount, admission, and/or the like, the client dispatches a text message received by him/her, or some of it, in the form of a text message, by using the communication capabilities of his/her data processing device, through a communications centre for further processing, which enables the redemption/supply of a particular transaction, such as the transfer of a purchase, a betting, lottery, raffle prize, a coupon offer and/or the like to the client, or his/her admission to an event/venue and/or the like, after the verification of a code or the like contained in the text message.

The principal benefits gained by a method of the invention include simplicity and reliability of its operating principle, whereby especially the completion of a so-called electronic commercial transaction can be verified in the most diverse of practical contexts and applications while effectively minimizing the need for extra large-scale computer hardware and communication links. One essential benefit in a method of the invention is first of all that a service provider can dramatically simplify his/her hardware stock, since, for example, all information per purchase transaction need not be necessarily forwarded in its current extent to other servers or to an entire sales network. However, the most essential feature lies in the fact that the completion of commercial transactions will be markedly simplified with regard to both a service provider and a client, since for example an acquired product, service, or payment can be redeemed or claimed in a simple manner and immediately as the client delivers a text message received by him/her to a communications centre for its further processing, after which the service supplier can immediately hand over/transfer the discussed transaction to this particular client, after receiving a confirmation that the verification result is at least acceptable.

Another essential benefit gained by the invention is particularly the fact that its operation can be largely based on presently available standards, i.e. on the fact that a customer receives a code in his/her mobile phone in the form of a text message, that the customer dispatches the code further in the form of a text message by using the text communication capabilities of his/her mobile phone for enabling redemption, and that the verification result is reported for example to a pager by standard methods. The fact that the inventive operation can be based on currently existing infrastructures enables the invention to be deployed immediately in full scale with quite low investments. Respectively, a service provider can use the system to serve as large a number of clients as possible, since for example in Europe and several other areas there are in practice more text communication capable mobile phones in operation than any other portable data processing devices, which could be used for carrying out a redemption process.

In the following specification the invention will be described in detail while reference is made to the accompanying drawing, which represents diagrammatically one preferred operating principle for a method of the invention.

The invention relates to a method for the redemption/transfer of a product, service, payment and/or the like, whereby a customer A has received in his/her portable data processing device, such as a mobile phone or the like, equipped with communication links, from a service provider, such as a vendor, a server and/or the like, in the form of a text message Xt an electronic coupon, ticket, betting slip and/or the like, which contains a code or the like for enabling the redemption/transfer of a product, service, payment and/or the like in a controlled fashion. For claiming a product, service, payment, betting prize, discount, admission, and/or the like, the client A dispatches the text message Xt received by him/her, or some of it, in the form of a text message, by using the communication capabilities of his/her data processing device, through a text communications centre VK for further processing, which enables the redemption/supply of a particular transaction, such as the transfer of a purchase, a betting, lottery, raffle prize, a coupon offer and/or the like to the client, or his/her admission to an event/venue and/or the like, after the verification of a code or the like contained in the text message Xt. Hence, the client or customer can claim e.g. a service redeemed by him/her for example as a cash payment, as a text message in his/her mobile phone, or as a deposit directly in his/her account. The service received as a text message may also be for example in the form of another text message for the customer to redeem another service, etc.

In addition to a code carried by a text message, the customer can naturally supply the communications centre with other data, as well, such as his/her home address, mobile phone number, account number, or other such information, for enabling transfer of a service. Moreover, a text communication transmitted to the communications centre can be augmented on the part of a customer to include a message about which redemption point/service supplier is in question, i.e. for example the identification number of a store, a shop, or a person that the customer is about to claim his/her service/product from, in order to report the verification result to a proper place/person.

In a particularly preferred embodiment, the client A redeems or claims a product, service, payment, betting prize, discount, admission, and/or the like physically, i.e. in direct contact with a service supplier PL. On the other hand, in a still preferred embodiment, the text message Xt is delivered to the client A after being processed by a concealing system, such as in an encrypted form or e.g. provided with a digital signature, particularly for verifying authenticity of the text message. The text message can be encrypted partially or completely, or preferably just for the code to be verified, for confirming authenticity of the redemption right.

In reference to the enclosed basic operating diagram, the text message Xt in its entirety, or at least a code or the like included therein, is transmitted further to a checking system TJ which checks the code for confirming its authenticity and/or validity, as well as, if necessary, checks the text message or code for its contents in order to determine which service, product, payment and/or the like said client A is entitled to on the basis of this particular coupon, ticket, betting slip, and/or the like. After this, the checking system TJ forwards a verification result T immediately to the service supplier PL.

Upon receiving a message about the verification result T, the service supplier PL gives the customer A a product, service, payment, and/or the like, such as a discount, prize, product, service, and/or the like, to which he/she is entitled to on the basis of the text message Xt. At this point, a code or the like is verified by the checking system TJ for its authenticity and/or validity by decrypting the text message, the code, or the like, and/or by comparing the text message, the code, or the like with its database.

A message regarding a verification result and/or check T is delivered on the part of the checking system TJ, most preferably in an electronic mode, such as in the form of a text message and/or e-mail, to the service supplier's PL and/or the client's (A) data processing device, such as a mobile phone, a telephone, a pager, a computer data card, or in a similar fashion, whereby the service supplier and/or the client shall ultimately receive a message regarding the verification result.

In a further preferred embodiment, the verification result T is delivered in an electronic mode to an automated actuator TL, which enables the supply of a purchase, such as a service, a product, and/or the like, or the admission to an event/venue in a computerized manner. At this point, in yet another preferred embodiment, the verification result T is delivered electronically to the control of an automated entrance system TL for opening mechanically e.g. a turnstile, a door, a lock, and/or the like.

In still another preferred embodiment of the method, the verification result T is delivered in an electronic mode, comprising information about whether a ticket, a betting slip, and/or the like has been accepted/rejected, information about what the present code provides entitlement to, instructions for guiding a customer to enable a redemption/transfer, a password for giving a customer the right of redemption, a new redemption code, such as a coupon, an admission ticket, and/or a ticket to participate in a lottery, and/or the like information.

It is obvious that the invention is not limited to the embodiments described or explained above, but it can be varied as necessary within the scope of the basic inventive concept. First, it should be noted that e.g. the communications centre may comprise a single common communications centre with a single telephone number, or it may be constituted by a larger entity, comprising a plurality of telephone numbers. Respectively, the checking system may be constituted by a verification server for codes, which is managed e.g. by a third party or an ASP (Application Service Provider). Firstly, the text message received by a client, enabling the redemption of a service, may contain one or several codes. On the other hand, the communications centre and the checking system may also be physically one and the same system. Respectively, the service supplier can be e.g. a newsstand, an automated dispenser, a waiter in restaurant, or the like. Furthermore, the issuer of an actual coupon, ticket, or the like (i.e. the original service provider) can be a party other than the service supplier but, naturally, those two may also be constituted by one and the same party. Similarly, the original recipient of a code-containing text message, i.e. the acquirer or the recipient of a direct marketing coupon, is not necessarily the same person as the user of the text message/code, i.e. for example, the claimant of an acquisition or the exploiter of a direct marketing coupon. Clients are also capable of sending a code-containing text message from client to client, for example by using the text communication capabilities of their telephones. Thus, neither does the device used for redemption need to be the same as the one having received the original text message.

The above-described first sequence, i.e. the delivery of a text message to a customer, can also be effected in many ways, e.g. in the form of direct advertising (coupons) or as a result of a client's purchasing process (tickets and betting slips). Respectively, in a second sequence, i.e. as a client requests to claim his/her purchased product, service, or e.g. a betting prize won by him/her, the telephone number, which establishes contact with the communications centre and to which the text message is transmitted, can be a number common to a number of different service providers or e.g. specific to a service supplier/provider. The telephone number may also be e.g. an ordinary mobile phone number, which is connected e.g. to an ordinary computer or a portable computer functioning as a checking system. Consequently, the text communications centre can be for example a telephone operator's text messaging center, a server, a combination of an ordinary computer and a mobile phone, or any data system, which has a capability of receiving text messages, as well as processing the same at least by forwarding the same to a checking system.

In this context, one preferred operating principle could be such that the discussed device comprises a portable computer maintained by a service supplier, such as a newsstand keeper, which has integrated therein e.g. a telephone card, whereby this combination could function both as a communications centre receiving a text message, a checking system for codes, and as a terminal apparatus which discloses the verification result to the service supplier.

Furthermore, in a third sequence it is possible that, along with a text message, the communications centre transmits, in addition to a code giving entitlement to claim a service, also other possible information to the checking system, e.g. a client's telephone number.

A fourth sequence, relating to the delivery of a verification result, can also be implemented in a variety of ways. In addition, the verification result may contain highly diversified information, at least, however, a message regarding whether a coupon, a ticket, or a betting slip is authentic and/or valid. In practice, the verification result always contains a message, indicating also which service, product, payment/discount a client is entitled to on the basis of a coupon, a ticket, or a betting slip. It is important to note that the verification result can be disclosed to various terminal devices in the possession of service providers, such as computers, PDA devices, mobile phones, pagers, or the like, by many different methods, such as in the form of an e-mail or a text message.

Furthermore, a final sequence, i.e. the actual transfer/redemption of a product, a service, a payment, and/or the like, can be implemented preferably e.g. in such a manner that a purchase/service is supplied e.g. by a waiter or a cashier, or a product is supplied automatically to a customer by an automated dispenser (e.g. a softdrink dispenser). Hence, the above refers to the case that the client is indeed physically to the case that the client is indeed physically present to claim a service, product, payment, and/or the like entitled by a text message, such as a coupon discount, a betting prize, etc., immediately from a service supplier, which can be a firm, an association, a person, a machine/apparatus, etc.

Naturally, it is obvious that a single code can be used for claiming a number of various services, products, or the like, i.e. a client can use a single code to claim both admission to an event and a monetary prize from a cashier. Respectively, the actuator TL can be for example an automated newspaper dispenser, an automated kiosk, an automated claiming point for betting prizes, an automated keeper for keys, an automated softdrink dispenser, a turnstile in an entrance system, or some other automated arrangement capable of supplying a customer with a service, a product, or the like.

1. A method of commerce comprising:
Purchasing a magazine, the magazine being provided with a unique identification means (UN),
Providing sufficient personal information (SPI) to enable the purchaser to be identified,
Sending the UIM and the SPI to a database,
Selecting at least one winner from the database, and
Providing a reward to the at least one winner.

2. The method as claimed in claim 1, wherein the unique identification means comprises a unique number.

3. The method as claimed in claim 1, wherein the unique identification means comprises a barcode.

4. The method as claimed in claim 3, wherein the unique identification means is on the front page of the magazine.

5. The method as claimed in claim 1, wherein the unique identification means is anywhere in the magazine except on the front page.

6. The method as claimed in claim 1, wherein the unique identification means is covered until after purchase of the magazine.

7. The method as claimed in claim 1, wherein the magazine is a printed magazine.

8. The method as claimed in any one of claim 1, wherein the magazine is an electronic magazine.

9. The method as claimed in claim 1, wherein the magazine is selected from the group consisting of: a lifestyle magazine, an entertainment magazine, a personal investment or financial type magazine, a personal growth magazine, a magazine dealing primary with cars, bikes, boats, or other goods or services which would be desirable to have.

10. The method as claimed in claim 1, wherein the sufficient personal information includes the person's name and address and telephone number.

11. The method as claimed in claim 1, wherein the sufficient personal information is given to the place where the magazine is purchased, or is provided online.

12. The method as claimed in claim 1, wherein a winner is selected at random from the database and the winner is identified on television.

13. The method as claimed in any one of claim 1, wherein a winner is selected at random from the database and is notified other than by television.
